(19) United States
(12) Patent Application Publication
(10) Pub. No.: US 2014/0111678 A1
(43) Pub. Date: Apr. 24, 2014

(54) METHOD AND SYSTEM FOR CAPTURING, STORING AND DISPLAYING ANIMATED PHOTOGRAPHS

(71) Applicant: ASHISH VIKRAM, Bangalore (IN)

(72) Inventor: Ashish VIKRAM, Bangalore (IN)

(73) Assignee: Ashish Vikram, Balgalore (IN)

(21) Appl. No.: 13/654,433

(22) Filed: Oct. 18, 2012

(51) Int. Cl. H04N 5/222

(52) U.S. Cl. 348/333.01; 348/E05.022

(57) ABSTRACT

A method and system for capturing, storing and displaying animated photographs. The method includes receiving a click input from a user of a digital camera. The method also includes determining an animation mode of the digital camera and a plurality of parameters associated with the animation mode. The method further includes enabling capturing of an animated photograph based on the animation mode. The animated photograph includes a plurality of frames. Further, the method includes storing each frame of the plurality of frames as an animated image format on the digital camera and combining the plurality of frames as a file. Moreover, the method includes displaying the plurality of frames of the animated photograph at a speed in accordance with speed information stored along with the file. The system includes one or more electronic devices, a digital camera, communication interface, memory, and processor.

### TECHNICAL FIELD

Embodiments of the disclosure relate to the field of animated photographs.

### BACKGROUND

In current technology, a user has an option of either taking still photographs or videos using a digital camera. A still photograph requires less storage space for a similar display size and resolution compared to a video but has a disadvantage of not being able to capture motion. For example, the still photograph can capture a frozen smile but not an act of smiling. Despite this drawback, the still photographs are a primary form of sharing memories and moments on web as the videos are difficult to capture and are unsuitable for storage, uploading and downloading. Further, individual frames of the video cannot be easily printed or viewed without a decrease in quality. Moreover, speed of downloads for the videos is much slower than for the still photographs due to larger size for similar quality of each frame as the still photograph.

Digital cameras can operate in a continuous mode where the still photographs are captured one after another with a time interval between each still photograph. Each still photograph is digitally stored, usually in flash memory. However, the still photographs taken in the continuous mode have to be handled as separate files and cannot easily be animated.

In light of the foregoing discussion, there is a need for a method and system for an efficient technique to capture, store and display animated photographs.

### SUMMARY

The above-mentioned needs are met by a method, a computer program product and a system for capturing, storing and displaying animated photographs.

An example of a method of capturing, storing and displaying animated photographs includes receiving a click input from a user of a digital camera. The method also includes determining an animation mode of the digital camera and a plurality of parameters associated with the animation mode. The method further includes enabling capturing of an animated photograph based on the animation mode. The animated photograph includes a plurality of frames. Further, the method includes storing each frame of the plurality of frames as an animated image format on the digital camera and combining the plurality of frames as a file. Moreover, the method includes displaying the plurality of frames of the animated photograph at a speed in accordance with speed information stored along with the file.

An example of a computer program product stored on a non-transitory computer-readable medium that when executed by a processor, performs a method of capturing, storing and displaying animated photographs includes receiving a click input from a user of a digital camera. The computer program product also includes determining an animation mode of the digital camera and a plurality of parameters associated with the animation mode. The computer program product further includes enabling capturing of an animated photograph based on the animation mode. The animated photograph includes a plurality of frames. Further, the computer program product includes storing each frame of the plurality of frames as an animated image format on the digital camera and combining the plurality of frames as a file. Moreover, the computer program product includes displaying the plurality of frames of the animated photograph at a speed in accordance with speed information stored along with the file.

An example of a system for capturing, storing and displaying animated photographs includes one or more electronic devices and a digital camera. The system also includes a communication interface in electronic communication with the one or more electronic devices. The system further includes a memory that stores instructions, and a processor. The processor is responsive to the instructions to receive a click input from a user of a digital camera. The processor is also responsive to the instructions to determine an animation mode of the digital camera and a plurality of parameters associated with the animation mode. The processor is further responsive to the instructions to enable capturing of an animated photograph based on the animation mode. The animated photograph includes a plurality of frames. Further, the processor is responsive to the instructions to store each frame of the plurality of frames as an animated image format on the digital camera and combine the plurality of frames as a file. Moreover, the processor is also responsive to the instructions to display the plurality of frames of the animated photograph at a speed in accordance with speed information stored along with the file.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments can be implemented;

FIG. 2 is a block diagram of a digital camera, in accordance with one embodiment; and

FIG. 3 is a flowchart illustrating a method of capturing, storing and displaying animated photographs, in accordance with one embodiment.

### DETAILED DESCRIPTION OF THE EMBODIMENTS

The above-mentioned needs are met by a method, computer program product and system for capturing, storing and displaying animated photographs. The following detailed description is intended to provide example implementations to one of ordinary skill in the art, and is not intended to limit the invention to the explicit disclosure, as one or ordinary skill in the art will understand that variations can be substituted that are within the scope of the invention as described.

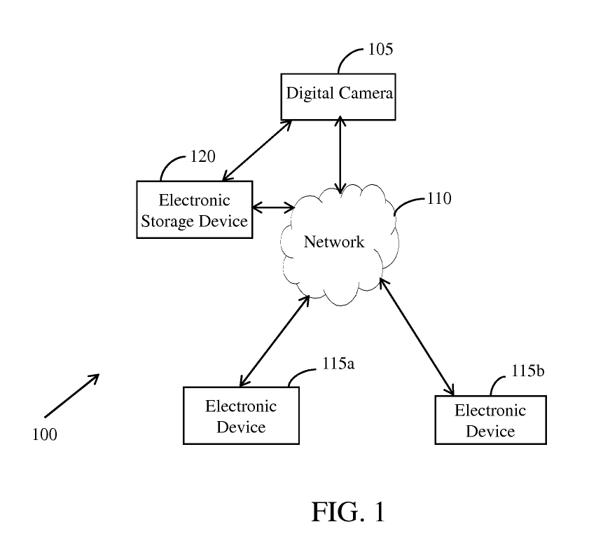

FIG. 1 is a block diagram of an environment 100, in accordance with which various embodiments can be implemented.

The environment 100 includes a digital camera 105 connected to a network 110. The environment 100 further includes one or more electronic devices, for example an electronic device 115a and an electronic device 115b, which can communicate with each other through the network 110. Examples of the electronic devices include, but are not limited to, computers, mobile devices, tablets, laptops, palmtops, hand held devices, telecommunication devices, and personal digital assistants (PDAs).

The electronic devices can communicate with the digital camera 105 through the network 110. Examples of the network 110 include, but are not limited to, a Local Area Network (LAN), a Wireless Local Area Network (WLAN), a Wide Area Network (WAN), internet, and a Small Area Network (SAN). The electronic devices associated with different users can be remotely located with respect to the digital camera 105.

The digital camera 105 is also connected to an electronic storage device 120 directly or via the network 110 to store information, for example an animated photograph, and a plurality of frames.

In some embodiments, different electronic storage devices are used for storing the information.

In some embodiments, the digital camera 105 can be a standalone device or can be embedded in one of the electronic devices.

The digital camera 105 receives a click input from a user of the digital camera 105. An animation mode set by the user on the digital camera and a plurality of parameters associated with the animation mode are then determined. An animated photograph can further be captured based on the animation mode. The animated photograph includes a plurality of frames. Each frame is stored as an animated image format on the digital camera 105. The frames are further combined as a file on the digital camera 105. The digital camera 105 can subsequently display the frames of the animated photograph at a speed in accordance with speed information stored along with the file.

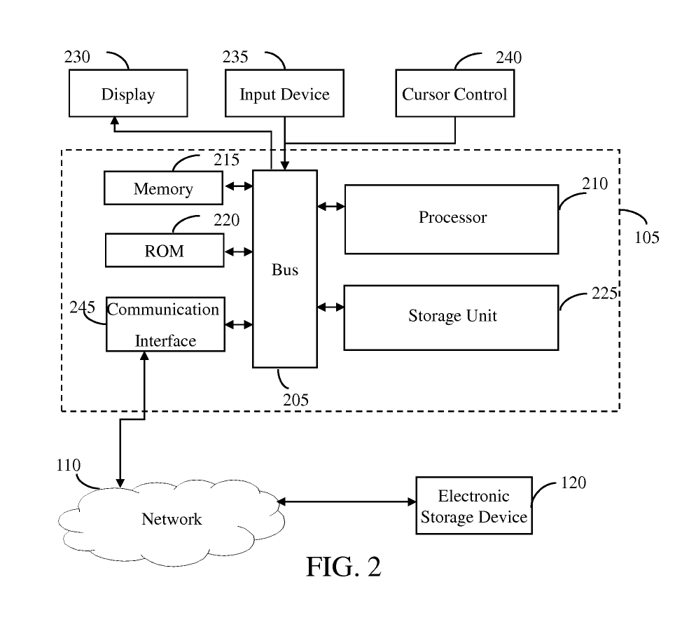

The digital camera 105 including a plurality of elements is explained in detail in conjunction with FIG. 2.

FIG. 2 is a block diagram of the digital camera 105, in accordance with one embodiment.

The digital camera 105 includes a bus 205 or other communication mechanism for communicating information, and a processor 210 coupled with the bus 205 for processing information. The digital camera 105 also includes a memory 215, for example a random access memory (RAM) or other dynamic storage device, coupled to the bus 205 for storing information and instructions to be executed by the processor 210. The memory 215 can be used for storing temporary variables or other intermediate information during execution of instructions by the processor 210. The digital camera 105 further includes a read only memory (ROM) 220 or other static storage device coupled to the bus 205 for storing static information and instructions for the processor 210. A storage unit 225, for example a memory card, is provided and coupled to the bus 205 for storing information, for example an animated photograph, and a plurality of frames as still photographs.

The digital camera 105 can be coupled via the bus 205 to a display 230, for example a cathode ray tube (CRT), and liquid crystal display (LCD) for displaying the animated photograph. An input device 235, including alphanumeric and other keys, is coupled to the bus 205 for communicating information and command selections to the processor 210. Another type of user input device is a cursor control 240, for example a mouse, a trackball, or cursor direction keys for communicating direction information and command selections to the processor 210 and for controlling cursor movement on the display 230. The input device 235 can also be included in the display 230, for example a touch screen.

Various embodiments are related to the use of the digital camera 105 for implementing the techniques described herein. In some embodiments, the techniques are performed by the digital camera 105 in response to the processor 210 executing instructions included in the memory 215. Such instructions can be read into the memory 215 from another machine-readable medium, for example the storage unit 225. Execution of the instructions included in the memory 215 causes the processor 210 to perform the process steps described herein.

In some embodiments, the processor 210 can include one or more processing units for performing one or more functions of the processor 210. The processing units are hardware circuitry used in place of or in combination with software instructions to perform specified functions.

The term “machine-readable medium” as used herein refers to any medium that participates in providing data that causes a machine to perform a specific function. In an embodiment implemented using the digital camera 105, various machine-readable media are involved, for example, in providing instructions to the processor 210 for execution. The machine-readable medium can be a storage medium, either volatile or non-volatile. A volatile medium includes, for example, dynamic memory, for example the memory 215. A non-volatile medium includes, for example, memory cards, for example the storage unit 225. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic media, a CD-ROM, any other optical media, punchcards, papertape, any other physical media with patterns of holes, a RAM, a PROM, and EPROM, a FLASH-EPROM, any other memory chip or cartridge.

In another embodiment, the machine-readable media can be transmission media including coaxial cables, copper wire and fiber optics, including the wires that comprise the bus 205. Transmission media can also take the form of acoustic or light waves, such as those generated during radio-wave and infra-red data communications. Examples of machine-readable media may include, but are not limited to, a carrier wave as described hereinafter or any other media from which the digital camera 105 can read, for example online software, download links, installation links, and online links. For example, the instructions can initially be carried on a magnetic disk of a remote computer. The remote computer can load the instructions into its dynamic memory and send the instructions over a telephone line using a modem. A modem local to the digital camera 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on the storage unit 225 either before or after execution by the processor 210. All such media must be tangible to enable the instructions carried by the media to be detected by a physical mechanism that reads the instructions into a machine.

The digital camera 105 also includes a communication interface 245 coupled to the bus 205. The communication interface 245 provides a two-way data communication coupling to the network 110. For example, the communication interface 245 can be an integrated services digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

The digital camera 105 is also connected to the electronic storage device 120 to store the animated photograph, and the plurality of frames.

The processor 210 in the digital camera 105 receives a click input from a user of the digital camera 105. The processor 210 determines an animation mode of the digital camera and a plurality of parameters associated with the animation mode. The processor 210 enables capturing of an animated photograph based on the animation mode. The animated photograph includes a plurality of frames. The processor 210 stores each frame of the frames as an animated image format on the digital camera. The processor 210 further combines the frames as a file. The processor 210 further displays the plurality of frames of the animated photograph at a speed in accordance with speed information stored along with the file.

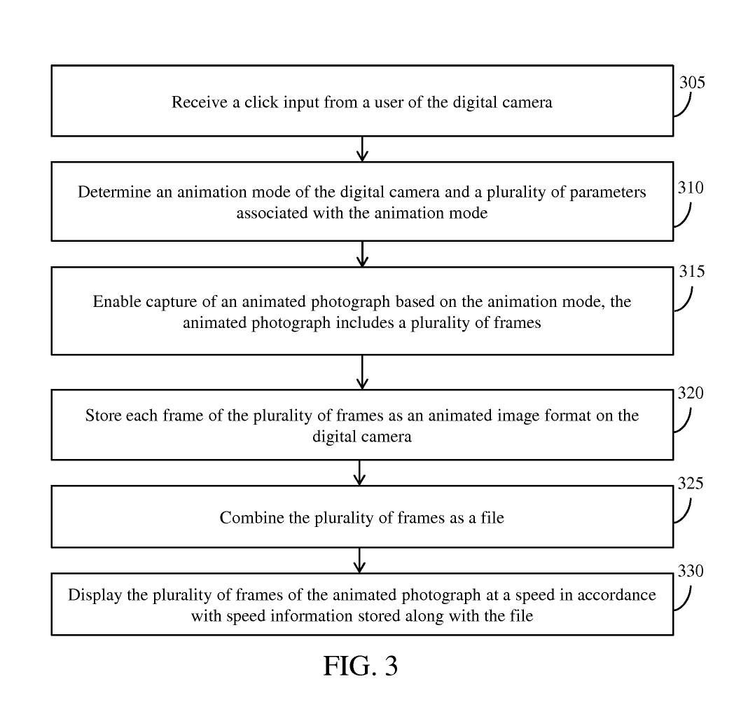

FIG. 3 is a flowchart illustrating a method of capturing, storing and displaying animated photographs, in accordance with one embodiment. The animated photographs are similar in size to a still photograph of similar quality and size and can therefore be shared, uploaded and downloaded similar to still photographs. The present disclosure thus allows capturing an act of smiling or blowing candles on a cake in an animated photograph.

At step 305, a click input is received from a user of the digital camera. The user can provide the click input using a click button on the digital camera. The click input can be received by a processor of the digital camera, for example the processor 210 in the digital camera 105.

At step 310, an animation mode of the digital camera and a plurality of parameters associated with the animation mode is determined. The animation mode that is set by the user is first determined. The animation mode can be one of a continuous animation mode and a fixed time animation mode. The parameters include total time duration of the frames and time interval between the frames.

At step 315, an animated photograph is enabled to be captured based on the animation mode. The user can capture the animated photograph by setting the digital camera is to the animation mode. The animated photograph that is captured includes a plurality of frames.

At step 320, each frame of the frames is stored as an animated image format on the digital camera. Examples of the animated image format include, but are not limited to, an Animated Portable Network Graphics (APNG) format and a WebP format.

At step 325, the frames are combined as a file. The animated image format allows multiple frames to be stored together in one file making it much easier to handle. The file can further be uploaded, downloaded and copied as one unit. In one example, the animated photograph can be included in hypertext markup language (html) and viewed in a web browser without plug-ins and can be uploaded to photo sharing sites, for example Flickr or Facebook.

At step 330, the frames of the animated photograph are displayed at a speed in accordance with speed information stored along with the file. The file can display the frames as an action sequence when viewed in a viewer that supports the animated image format.

In one example, in the continuous animation mode, the digital camera continues to shoot frames while the click button is pressed similar to a continuous mode for still photographs at a pre-determined speed, for example 5 frames per second. The digital camera can allow the user to change default speed as a setting for the continuous animation mode. Each frame is stored in temporary storage on the digital camera as it is shot. When the click button is lifted, the frames shot are combined and stored as a single APNG or WebP file on the digital camera. Appropriate speed information, for example 5 frames per second, is stored as part of the file so it plays the frames back at normal speed when viewed. The user can control time duration of the animated photograph in the continuous animation mode.

In another example, in the fixed time animation mode, time duration of the animated photograph is fixed. A default value of 1 second is usually fixed but the digital camera can allow the user to vary the time duration. The digital camera can also allow the user to vary default speed as another setting for the fixed time animation mode. The digital camera shoots frames for specified time duration each time the click button is pressed at a specified speed. If the time duration is fixed to one second and the speed to 5 frames per second, the digital camera shoots 6 frames at equal intervals over a 1 second time period when the user clicks the click button. The 6 frames are shot at time periods 0/100, 20/100, 40/100, 60/100, 80/100 and 100/100 over a 1 second interval. The frames shot are stored in an APNG or WebP file similar to the continuous animation mode.

In some embodiments, several browsers are already capable of displaying images having the animated image format and others can be extended to display animation in an image having the animated image format. A browser that is not aware of the animated image format is still able to display the image with the animated image format but only a first frame is displayed.

In some embodiments, each frame in a file can be printed or extracted as a separate unit or still photograph if the user so desires. In a viewing mode, the user can be provided an option of separating out any individual frame and storing it as a still photograph in a standard format, for example Joint Photographic Experts Group (JPEG) format, Portable Network Graphics (PNG) format, or Tagged Image File Format (TIFF), by pressing a store frame button.

In some embodiments, a viewing application is modified on the digital camera such that files in the animated image format can be recognized and viewed in a screen of the digital camera as animated photographs running at the normal speed or can be viewed frame by frame by pressing a next frame button.

In some embodiments, the animated photograph and the frames can be stored in an electronic storage device, for example the electronic storage device 120.

In other embodiments, the animated photograph and the frames can be stored in a storage unit, for example the storage unit 225, in a digital camera, for example the digital camera 105.

The present disclosure allows a user to capture an event as an animated photograph by using a digital camera. The animated photograph can further be uploaded to a social networking site, displayed in a web browser, or made part of a digital magazine. The present disclosure can be implemented by an appropriate software upgrade to current digital cameras without requiring additional hardware. Additional hardware, for example an animated mode button, can be provided to allow users to switch to and between animated modes easily and to view animated photographs in a frame by frame mode and store individual photographs. Each frame is usually of much higher resolution and clarity than frames in a video while storage requirements are closer to that of a still photograph rather than a complete video. The size of an animated photograph is smaller as compared to a video thereby making the animated photograph more suitable for embedding in an html page.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

1. A method of capturing, storing and displaying animated photographs, the method comprising:
receiving a click input from a user of a digital camera;
determining an animation mode set by the user of the digital camera and a plurality of parameters associated with the animation mode;
enabling capturing of an animated photograph based on the animation mode, wherein the animated photograph comprises a plurality of frames captured in a still mode to display an animation effect;
storing each frame of the plurality of frames as an animated image format on the digital camera, wherein said frame can be at least one of uploaded, downloaded and copied as a single unit further, wherein each frame is stored in a temporary storage on the digital camera and said frames shot are combined and stored as a single file;
combining the plurality of frames as a file, wherein parameters including duration of the frames, default speed and time interval between the frames are adjusted; and
displaying the plurality of frames of the animated photograph at a speed in accordance with speed information stored along with the file, wherein said displayed frame is displayed in a form of an action sequence, further wherein said action sequence supports an animated image format.

2. The method as claimed in claim 1, wherein the animation mode comprises a continuous animation mode and a fixed time animation mode, wherein said digital camera continues to shoot one or more frames for at least one still photograph at a pre-determined speed.

3. The method as claimed in claim 1, wherein the plurality of parameters comprises at least one of total time duration of the plurality of frames and time interval between the plurality of frames, wherein each frame is stored in a temporary storage area on the digital camera.

4. The method as claimed in claim 1 further comprising
enabling viewing of the animated photograph on a screen of the digital camera, wherein the viewing is enabled by playing the frames back at normal speed.

5. The method as claimed in claim 4 further comprising
enabling viewing of the plurality of frames as individual frames; and
storing said individual frames as at least one still photograph.

6. The method as claimed in claim 1 further comprising uploading the animated photograph to one or more electronic devices, wherein the user can control the animated photograph in the continuous animation mode.

7. A computer program product stored on a non-transitory computer-readable medium that when executed by a processor, performs a method of capturing, storing, and displaying animated photographs, comprising:
receiving a click input from a user of a digital camera;
determining an animation mode set by the user of the digital camera and a plurality of parameters associated with the animation mode;
enabling capturing of an animated photograph based on the animation mode, wherein the animated photograph comprises a plurality of frames captured in a still mode to display an animation effect;
storing each frame of the plurality of frames as an animated image format on the digital camera, wherein said frame can be at least one of uploaded, downloaded and copied as a single unit further, wherein each frame is stored in a temporary storage on the digital camera and said frames shot are combined and stored as said single unit;
combining the plurality of frames as a file, wherein parameters including at least one of duration of the frames, default speed and time interval between the frames are configured to be adjusted; and
displaying the plurality of frames of the animated photograph at a speed in accordance with speed information stored along with the file, wherein said displayed frame is displayed in a form of an action sequence, further wherein said action sequence supports an animated image format.

8. The computer program product as claimed in claim 7, wherein the animation mode comprises a continuous animation mode and a fixed time animation mode, wherein said digital camera continues to shoot one or more frames for at least one still photograph at a pre-determined speed.

9. The computer program product as claimed in claim 7, wherein the plurality of parameters comprises at least one of total time duration of the plurality of frames and time interval between the plurality of frames, wherein each frame is stored in a temporary storage area on the digital camera.

10. The computer program product as claimed in claim 7 further comprising
enabling viewing of the animated photograph on a screen of the digital camera, wherein the viewing is enabled by playing the frames back at normal speed.

11. The computer program product as claimed in claim 10 further comprising
enabling viewing of the plurality of frames as individual frames; and
storing said individual frames as at least one still photograph.

12. The computer program product as claimed in claim 7 further comprising
uploading the animated photograph to one or more electronic devices, wherein the user can control the animated photograph in the continuous animation mode.

13. A system for capturing, storing and displaying animated photographs, the system comprising:
one or more electronic devices;
a digital camera;
a communication interface in electronic communication with the one or more electronic devices;
a memory that stores instructions; and
a processor responsive to the instructions to
receive a click input from a user of the digital camera;
determine an animation mode set by the user of the digital camera and a plurality of parameters associated with the animation mode;
enable capturing of an animated photograph based on the animation mode, wherein the animated photograph comprises a plurality of frames captured in a still mode to display an animation effect;
store each frame of the plurality of frames as an animated image format on the digital camera, wherein said frame can be at least one of uploaded, downloaded and copied as a single unit further, wherein each frame is stored in a temporary storage on the digital camera and said frames shot are combined and stored as said single unit;
combine the plurality of frames as a file, wherein parameters including at least one of duration of the frames, default speed and time interval between the frames are configured to be adjusted; and
display the plurality of frames of the animated photograph at a speed in accordance with speed information stored along with the file, wherein said displayed frame is displayed in a form of an action sequence, further wherein said action sequence supports an animated image format.

14. The system as claimed in claim 13 further comprising
an electronic storage device that stores the animated photograph, and the plurality of frames.

15. The system as claimed in claim 13, wherein the animation mode comprises a continuous animation mode and a fixed time animation mode, wherein said digital camera continues to shoot one or more frames for at least one still photograph at a pre-determined speed.

16. The system as claimed in claim 13, wherein the plurality of parameters comprises at least one of total time duration of the plurality of frames and time interval between the plurality of frames.

17. The system as claimed in claim 13 further comprising
enabling viewing of the animated photograph on a screen of the digital camera, wherein the viewing is enabled by playing the frames back at normal speed.

18. The system as claimed in claim 17 further comprising
enabling viewing of the plurality of frames as individual frames; and
storing said individual frames as at least one still photographs.

19. The system as claimed in claim 13 further comprising
uploading the animated photograph to the one or more electronic devices, wherein the user can control the animated photograph in the continuous animation mode.
